(19) United States
(12) Patent Application Publication
(10) Pub. No.: US 2018/0133824 A1
(43) Pub. Date: May 17, 2018

(54) THREADING TOOLS WITH FLUID DUCTS

(71) Applicant: DC SWISS S.A., Malleray (CH)

(72) Inventors: Christian MEYER, Brislach (CH); Beat KAUFMANN, Malleray (CH)

(73) Assignee: DC SWISS S.A., Malleray (CH)

(21) Appl. No.: 15/410,112

(22) Filed: Jan. 19, 2017

(30) Foreign Application Priority Data
Nov. 11, 2016 (DE) 202016106331.0

(51) Int. Cl. B23G 5/00; B23G 5/06; B23G 5/18

(52) U.S. Cl. CPC B23G 5/005; B23G 5/06; B23G 2240/12; B23G 2200/48; B23G 5/18

(57) ABSTRACT

The present invention relates to a threading tool for producing a thread notch on a workpiece. The production may be both material-removing production and also chipless production. The threading tool comprises at least two regions, a distal machining region with a machining head, and a proximal shank region with a shank, which shank narrows toward the machining region via a shoulder. Furthermore, the threading tool according to the invention is designed such that at least one fluid duct extends through the shank, which at least one fluid duct opens out in the machining region.

### TECHNICAL FIELD

The present invention relates to a threading tool for producing a thread notch on a workpiece, as per the preambles of the independent claims. The present invention relates in particular to threading tools for producing threads both by way of a material-removing, that is to say chip-removing, process and by way of a process based on cold working.

### PRIOR ART

Threads are notches, which have been used since time immemorial for the fastening of at least two elements to one another, which normally assume the form of a spiral-shaped groove and a corresponding counterpart. The special feature of a thread is not only that two elements can be connected to one another by means thereof, but also that an axial movement of the elements is made possible by way of a rotational movement of at least one of the two elements about its longitudinal axis. Threads are generally industrially standardized, wherein one standard thread is a thread with a flank opening of the groove of 60°. Depending on the intended use, it is however possible to realize a wide variety of flank opening angles and flank shapes, even as far as inclined grooves. Single-flight threads are commonly used for screw connections. Multi-flight threads are commonly used for motion connections with a corresponding stroke. For adjustments, so-called fine threads are used, which are distinguished by a relatively small selected pitch.

A thread pair is generally composed of a male part, a screw, and the female counterpart, the nut. The screw generally has an external thread, whereas the nut has a corresponding internal thread. Correspondingly, a different threading tool may be required for the production of a screw than, for example, for the production of a nut with an internal thread.

Broadly speaking, tools for producing a thread notch can be divided into two categories of machining methods. The first category encompasses all chip-removing tools such as thread taps, thread milling cutters or the erosion of threads. The second category encompasses forming threading tools which create the thread notch by pressing, rolling or plastic deformation of any other form. Threading tools which produce the thread notch both partially by chip removal and partially by forming have also long been known.

Threading tools may alternatively also be divided into two categories on the basis of the threading tool movement relative to the workpiece.

The first category encompasses threading tools which rotate about their own tool axis and which simultaneously perform merely an axial feed motion of the magnitude of the pitch per rotation.

Here, it is of secondary importance whether the tool or the workpiece performs the described movement. The chip removal or deformation of the thread notch to be produced takes place within a small number of tool rotations or workpiece rotations. In the case of a standard thread of size M6, for example, the pitch is standardized to 1 mm with a thread depth of 10 mm. This yields, in the case of a chamfer length of the threading tool for internal machining of two times the pitch, a fully produced thread notch after just 12 rotations. This category of threading tools also includes thread taps, thread formers, circular screwing dies, combination thread taps but also thread rollers.

The second category encompasses threading tools, such as thread milling cutters, thread-whirling cutters and bore thread milling cutters, which are distinguished by the fact that, aside from the rotation about the tool axis and the axial feed motion, a lateral movement is performed about the tool axis or about the bore axis or journal axis. The relative movement between threading tool and workpiece describes a helix.

U.S. Pat. No. 3,220,032 (Van Vleet, J. M.), hereby incorporated by reference, describes a thread tap of said type as discussed in the introduction. The tool that is presented comprises a shank and a tapering toothed tool head, having four cutting edges which are arranged in a cross shape with respect to one another and rotationally symmetrically with respect to a central longitudinal axis. The tooth rows have a toothing which, in a proximal direction proceeding from the distal end, increases from a flattened form to a form which tapers to a point. Owing to the form which tapers to a point and the initially broad teeth, it is made easier for the tool to penetrate into the material to be machined. In particular, said document describes two types of chamfer, firstly a cylindrical chamfer and secondly a conical chamfer. A multiplicity of possible chamfer forms is known. Here, the elements such as the outer diameter, the front tooth flank, the rear tooth flank and the thread base may have forms which deviate from one another, or, as presented in Van Vleet, may form different spacings to the tool axis. This yields a multiplicity of design possibilities for the chipped cross section. The ultimately resulting form of the thread is formed by the teeth which correspond to the widest circumferential radius of the tool about its central axis of rotation. The distal teeth on the machining head, known as chamfer, serve for the penetration of the tool and perform the actual material removal during the machining of the workpiece. The proximal tooth rows of the machining head are the so-called guide teeth and serve for the guidance of the thread tap during the machining. Normally, the guide teeth have a slight relief owing to the undercut and/or a slight conicity. Both the chamfer teeth and the guide teeth may be interrupted by any desired free-form, which, in the case of the chamfer teeth, results in a change in the chipped cross section and, in the case of the guide teeth, changes the contact surfaces between tool and workpiece, which changes the self-guiding characteristics of the thread tap. In particular, braking or inhibiting forces are thereby changed.

WO 98/10882 (Turchan, N., C.) Presents a combined tool which drills and produces a thread. Said tool may however be used, detached from the drilling function, merely for the milling of a thread notch. The presented tool likewise comprises a shank for connection to a machine tool, and a tool head with a row of machining edges, with a drilling edge and with at least one thread-tapping edge and a milling edge.

Corresponding control of the cutting/milling process is crucial for the correct formation of a thread notch using a tool of said type.

U.S. Pat. No. 3,775,792 (Leonard, D., L.) describes a thread former. The latter serves for producing a thread in an existing bore by way of a cold working process. Here, material is displaced and is not cut. The presented tool has a continuous shank and a tapering machining head on which forming elements, so-called pressing lobes, of substantially polygonal arrangement are arranged in spiral fashion about a central longitudinal axis.

All of said tools have in common the fact that, during the working process, they generate waste heat owing to friction, and particles and chips are formed during the material removal. Despite the deformation process rather than the chip-removing process, it is the case even in thread-forming methods that fine dust is formed owing to the friction of the tool against the workpiece. By contrast to the situation with a milling cutter, where the heat dissipation is possible primarily via the chips, the heat dissipation in the case of the thread tap and thread former takes place primarily via the tool itself.

The heat generation, in the form of heat of friction owing to the rotation of the tool, which arises in addition to the accumulation of material (chips and dust) in all of said methods can reduce the throughput or damage the tool. To improve the machining processes for the production of a thread notch, use is thus made of coolants and lubricants. Cooling may have the effect that output and throughput can be increased. The lubrication can furthermore counteract excessive wear of or welded deposits on the tool. It is also possible for relatively sensitive machining materials to be protected against damage caused by waste heat.

Furthermore, the accumulated material (chips and dust), if it is not discharged, can lead to a built-up edge. This effect is referred to as adhesive wear and is, in particular in the case of the thread tap and thread former, intensified by the fact that the heat dissipation takes place via the tool body itself, and promotes welded deposits of the chips and of the dust.

Furthermore, in the case of known tool geometries and recesses, adverse frequency effects may arise which may lead to a deterioration of the surface quality of a thread notch to be produced. This is the case in particular if the threading tool, in particular a thread tap, does not exhibit good running smoothness. Such effects may also lead to a reduction of the service life of the tool.

### PRESENTATION OF THE INVENTION

There is thus a demand to provide threaded tools of the type mentioned in the introduction which overcome at least one disadvantage of that which is known and which are in particular usable in an efficient manner. It is preferably sought to provide threading tools which have a longer service life.

At least one of said objects is achieved by way of a threading tool as per the characterizing part of the independent claims.

One aspect of the present invention relates to a threading tool for producing a thread notch on a workpiece. In the context of the present invention, the thread notch may be either the notch on a threaded nut, that is to say an internal thread, or the notch on a threaded screw, that is to say an external thread. A thread notch is in most cases a groove extending in spiral-shaped fashion on the circumference of a cylindrical body. The width, opening edge and/or depth of said groove is of secondary significance for the teaching of the present invention, and may be adapted and selected by a person skilled in the art, in accordance with his or her requirements, through the configuration and selection of the corresponding tool according to the invention. The threading tool according to the invention comprises at least two regions. Said threading tool comprises a first, distal machining region with a machining head, and a second, proximal shank region with a shank. In the context of the present invention, the expressions “distal” and “proximal” are used in each case proceeding from a machine tool to which the threading tool is operatively connected, wherein the distal end is the end further remote relative to the machine tool, whereas the proximal end is the end relatively close to the machine tool. At least one fluid duct extends through the shank of the threading tool according to the invention, which at least one fluid duct opens out in the machining region.

By way of said arrangement according to the invention of the threading tool, it is possible for fluid to be conducted to or drawn off from the machining head in targeted fashion.

In a particularly advantageous application, the fluid duct is used for conducting a coolant or a lubricant or a combined coolant and lubricant to the machining head. This may be performed during the machining. Here, the supply is preferably configured such that a fluidic connection exists between the machining region and the proximal end of the shank. Through said fluid connection, said coolant/lubricant can be conducted to the machining location.

An advantage of said threading tool is the longer service life by way of simultaneous internal and external cooling and the supply of a fluid to a machining zone, which is precise and permits a distribution of the fluid to the required location.

In a particular embodiment, the threading tool comprises a multiplicity of fluid ducts.

In a particular embodiment, substantially the entire shank region is bridged by the fluid duct.

In a particular embodiment, the shank has a greater diameter than all of the elements of the threading tool in the machining region. In other words, the shank has a diameter greater than the widest extent of the machining head. In this embodiment, the diameter relates to the threading tool diameter in a section plane perpendicular to the longitudinal axis of the threading tool.

In a particular embodiment, the threading tool is a thread tap. In the context of the present invention, a thread tap is a threading tool for the production of a thread notch by material removal in a chip-removing process. For the purposes of the present application, thread tapping and thread cutting are to be regarded as analogous methods.

Thread taps according to the invention may comprise at least one chip groove which will hereinafter also be referred to as recess. The combination of recess and lips yields the so-called cutting edge. Thread taps with 2, 3, 4, 5 or 6 recesses are conventional. The number of recesses increases tendentially with the nominal diameter of the thread tap. Here, the recesses may assume different shapes with regard to the shape perpendicular to the longitudinal axis of the tool, and may be composed of rounded and/or straight segments. Said geometries will be adapted by a person skilled in the art in accordance with the respective material to be machined. The recesses are arranged in each case rotationally symmetrically and have the same helix angle with respect to the longitudinal axis of the tool. Thread taps for blind holes predominantly have a recess of positive spiral-shaped form with the function of discharging chips in the direction of the proximal end, or the shank region of the tool. Here, helix angles of around 40° are the most commonly encountered. Thread taps for through holes predominantly have a combination of two recesses: a straight recess with a helix angle of 0°, and a curling chamfer with a negative spiral-shaped form. The negative helix angle of the curling chamfer has the effect that the chip discharge takes place in the distal direction from the proximal end.

A special characteristic of a thread tap is that, aside from the material-removing production of the thread notch, it is the case at the same time that a discharge of the chips is realized by way of correspondingly designed recesses on the tool. For this purpose, the thread tap may have corresponding structural features.

In a particular embodiment, the thread tap is a combination thread tap which permits the cutting of the core hole and of the thread in one working step. In a particular embodiment, the thread tap has cutting edges which follow one another in a rotational reaming process.

In a particular embodiment, the thread tap is composed of a high-speed steel. Alternatively, the thread tap is composed of a hard metal. In a particular embodiment, the thread tap is designed so as to ensure a discharge of the chips that are produced during the machining process; this is preferably ensured by way of chip grooves.

A particular alternative embodiment of the thread tap is a thread cutter. Said thread cutter may, in the context of the present application, be regarded as a tool for producing an external thread. In the case of a thread cutter of said type, the thread cutter is, for the production of a thread notch by material removal, designed as the counterpart to the thread to be produced on the corresponding bolt. The thread cutter is rotated over the bolt, and internal structures of the thread cutter remove material and produce the corresponding thread notch.

In a particular embodiment, the thread tap additionally comprises structures for transporting away chips that accumulate at the material removal location. In a simple embodiment, this may be ensured simply by virtue of the cutting elements having a corresponding geometry and having recesses arranged in positive spiral-shaped fashion, in negative spiral-shaped fashion or of straight-groove form around the machining head. In a particular embodiment, the transporting-away of chips that accumulate is ensured by way of a curling chamfer; this may be designed as a spiral groove which opens out in a recess, which is predominantly of straight-groove form.

In a particular embodiment, the thread tap comprises a multiplicity of recesses, in particular differently designed recesses. In a particularly preferred embodiment, the differently designed recesses have mutually different helix angles. In a further additional or alternative embodiment, the differently designed recesses are arranged asymmetrically and are provided with varying lip widths.

In a particular embodiment, the curling chamfer is designed so as to transition via a curve from a spiral-shaped recess into a recess of straight-groove form.

In a particular embodiment, the core radius of a recess varies along the longitudinal axis of the tool. The lowest point of the recess in a cross section with respect to the longitudinal axis of the threading tool, which lowest point is simultaneously the radially shortest distance to the longitudinal axis, is referred to as core radius.

In the case of a classic curling chamfer, it is for example the case that the smallest core radius is situated at the distal end of the machining region and increases progressively in the proximal direction, in particular as far as the centre of the machining region.

In a particular embodiment, the core radius varies linearly along the longitudinal axis of the threading tool.

In a particular embodiment, the core radius varies along the tool axis.

In a particular embodiment, the helix angle of the recess varies along the longitudinal axis of the threading tool.

In a particular embodiment, the threading tool is a thread former. A thread former according to the invention may be used for the manufacture both of an external thread and of an internal thread. The thread forming and the corresponding thread former are suitable for the chipless production of a thread notch. Here, the thread former is designed for producing the thread contour by displacement of the workpiece material in a stepped deformation process. Analogously to the thread tap, the thread former is preferably composed of a high-speed steel, though hard metals are also highly suitable. In a particular embodiment, the thread former has recesses analogously to the thread tap, but these have the function of a lubricating groove, and not for transporting away chips.

In a particular embodiment, the threading tool is a thread milling cutter. In the context of the present invention, thread milling cutting is a material-removing process for producing a thread notch in a chip-removing process. Thread milling cutters according to the invention may be designed for the production both of an internal thread and of an external thread. A thread milling cutter is particularly preferably designed for producing both an external thread and an internal thread. In a particular embodiment, the thread milling cutter is designed such that, in one step, in an external and internal machining process by material removal, it travels along a spatial helical structure such that the desired thread notch is removed from the tool.

Thread milling cutters according to the invention are preferably composed of hard metal or high-speed steel.

In a particular embodiment, the threading tool comprises a surface treatment and/or surface coating. The abrasion and wear resistance of the threading tool is increased by way of a surface treatment and/or surface coating. Furthermore, the selection of the corresponding coating agent or surface treatment can lead to a reduction in friction at the contact zone, and thus permit gentler thread production. In a particular embodiment, the threading tool comprises a surface treatment and/or coating selected from the group comprising: neutralization, vapour coating, nitriding, oxidization, hard chromium plating, chromium nitride coating, titanium nitride coating, titanium carbon nitride coating, titanium aluminium nitride coating and/or plastics coating. The threading tool may comprise a combination of several of the stated treatments and/or coatings.

In a particular embodiment, the shank region is separated from the machining region by a shoulder. Said separation may be advantageous inter alia for protection against chips and for more correct guidance of the tool on the workpiece. The shoulder is particularly preferably designed such that the shank narrows toward the machining head by way of the shoulder. The shoulder can thus be defined as a zone of the threading tool which extends substantially conically from the shank to the machining head.

In a particular embodiment, on the shoulder, there is provided at least one mouth at which the at least one fluid duct opens out in the machining region. Owing to the arrangement of the mouth on the shoulder, a fluid jet that is introduced into the machining region through the fluid duct can be used in targeted fashion. The mouth on the shoulder makes it possible, for example, for a fluid to be conducted in laminar fashion and substantially parallel to the longitudinal axis of the threading tool to the machining region. Owing to the mouth on the shoulder, it is also possible for the stability of the threading tool as a whole to be improved by virtue of the fact that the machining head remains free from fluid ducts and can be formed as a solid block.

In a preferred embodiment, the fluid duct runs parallel to the central longitudinal axis of the threading tool. In a particular embodiment, each fluid duct of the threading tool according to the invention runs parallel to the central longitudinal axis. In a particular embodiment, the fluid duct is branched within the shank. It is thus possible, for example, for an embodiment to be provided in which the fluid ducts branch within the threading tool. It is thus possible, for example, for a fluid duct in the proximal shank region to convey fluid into the distal machining region in a row of mouths. This may be realized by virtue of the fact that the fluid duct branches, within the shank, radially to the mouths arranged on the shoulder. Said branches preferably initially enclose an angle of less than 90° with respect to the central longitudinal axis before running parallel to said central longitudinal axis again. The fluid ducts are preferably, in the mouth region, that is to say in the distal 30% of the overall extent of the fluid duct, substantially parallel to the central longitudinal axis of the threading tool.

In a particular embodiment, it is the case in a threading tool according to the invention that a multiplicity of fluid ducts is provided, which fluid ducts are arranged radially around, and parallel to, a central longitudinal axis of the tool. In a particular embodiment, the fluid ducts are arranged radially around a central longitudinal axis of the tool such that the tool substantially maintains its rotational symmetry.

In a particular embodiment, the threading tool comprises three fluid ducts which are spaced apart from one another by 120° and which are arranged parallel to the longitudinal axis of the threading tool. In an alternative particular embodiment, the threading tool comprises four fluid ducts which are arranged parallel to the central longitudinal axis of the tool and which are spaced apart from one another by 90°. In a further alternative, particular embodiment, the threading tool comprises five fluid ducts which are arranged parallel to the longitudinal axis and which are in each case spaced apart from one another by an angle of 72°.

In a particular embodiment, the fluid ducts have a substantially circular diameter. In an alternative embodiment, the diameter of the fluid ducts is not circular; the diameter of the fluid ducts is preferably substantially half-moon-shaped. In a particular embodiment, the mouth is oval. Alternatively, the mouth is likewise half-moon-shaped, correspondingly to the cross section of the fluid ducts. The mouths of the fluid ducts preferably follow the tapering of the shoulder at which they are formed, and do not protrude therefrom. It may thus be realized as a result that, for example, fluid ducts with a circular cross section have an oval mouth.

In a particular embodiment, the fluid duct is designed so as to be of curved form about the central longitudinal axis. This may mean that a first inner wall of the fluid duct proceeding from the central longitudinal axis is smaller than a second inner wall proceeding from the second longitudinal axis. The transitions between the inner walls are preferably in the form of radii, and thus of curved form.

In a particular embodiment, the shaft has a clamping section.

In a particular embodiment, the threading tool comprises a multiplicity of cutting elements which are arranged so as to produce a thread notch by material removal.

In an alternative embodiment, the threading tool has a multiplicity of moulding elements which are designed to permit machining of a tool by cold working.

In a particular embodiment, the fluid ducts are formed as simple bores through the entire shank. Alternatively, the fluid ducts may be formed when a multi-part shank is assembled. For example, the shank may be formed as a shank body, which extends through a core of the shank and through the entire longitudinal axis, and a shank shell. Said shank shell or the corresponding shank core, or both, may be formed with recesses which, in the assembled state, define fluid ducts through the shank.

In a particular embodiment, the tool comprises in each case one fluid duct with in each case one mouth per cutting element and/or moulding element.

In a particular embodiment, the fluid ducts are oriented in a triangular cross-sectional arrangement with respect to the longitudinal axis.

In a particular embodiment, the mouths of the fluid ducts are arranged such that they come to life exactly between two cutting and/or moulding elements.

In a particular embodiment, the fluid ducts are of half-moon-shaped form. In the context of the present invention, this may be implemented such that the fluid duct comprises two fluid duct inner walls which are connected via a radius, wherein the first fluid duct inner wall is of curved form about the central longitudinal axis proceeding from the central longitudinal axis, that is to say from the inside toward the outside, and the second fluid duct is likewise of curved form, in particular with a gradient identical to the first fluid duct inner wall.

In a particular embodiment, the mouths are arranged such that a lateral supply of coolant is made possible. The mouths particularly preferably follow the profile of the shoulder and are bevelled, such that fluid can emerge substantially in the running direction of the fluid ducts.

In a particular embodiment, the mouths are designed such that the supply of fluid runs axially. In this way, with a simultaneous rotation of the tool about its own central longitudinal axis during operation, a fluid curtain can be generated, which permits an optimum supply of the fluid at the machining region.

A further aspect of the present invention relates to a threading tool comprising a distal machining region with a machining head and comprising a proximal shank region with a shank. In particular, said threading tool may be configured with one or more of the particular embodiments as discussed above, unless these are mutually exclusive or are contradictory to this aspect. The threading tool according to the invention comprises a machining region which has a multiplicity of cutting elements. The cutting elements are arranged radially around the central longitudinal axis of the tool and span a certain angle relative to one another. In the context of the present invention, the angle of the individual cutting elements may be measured in each case from cutting edge to cutting edge. Even though the cutting edges may, in particular embodiments, twist helically around the outer radius of the threading tool, it is provided in a preferred embodiment that they maintain an equal angular spacing to one another. The threading tool is furthermore designed such that at least two angles spanned in this way are of different magnitude. In other words, said threading tool is designed such that the cutting elements are not arranged rotationally symmetrically about a central axis of rotation of the threading tool. In a preferred embodiment, the cutting elements are arranged on a circumference about the central axis of rotation. Said circumference describes, overall, a 360° angle. In this particular embodiment, the cutting edges span, on said circumference, an angle which differs from cutting edge to cutting edge.

In a particular embodiment, the threading tool has three cutting elements and thus three cutting edges. In a particularly preferred embodiment, a first cutting edge is spaced apart from a second cutting edge by a first angle, and the second cutting edge is spaced apart from a third cutting edge by a second angle, which third cutting edge is in turn spaced apart from the first cutting edge by a third angle. The three angles together make up 360°. In a particularly preferred embodiment, the first angle spans an angle of 143°, the second angle spans an angle of 101°, and the third angle spans an angle of 116°.

In a particular embodiment, the threading tool comprises more than three cutting elements, and thus more than three cutting edges.

In a particular embodiment, the threading tool comprises a multiplicity of cutting elements, of which at least two cutting elements span an angle of different magnitude.

A further aspect of the present invention relates to a threading tool with variable helix angles. Said threading tool may also have any desired number of features of the first and/or second aspects of the present invention, unless these are mutually exclusive or are contradictory to the features of the third aspect of the present invention. The threading tool comprises a distal machining region with a machining head, and comprises a proximal shank region with a shank. The machining region comprises multiple recesses arranged around the machining head. The recesses extend in spiral fashion in the longitudinal direction of the tool about the axis of rotation. The threading tool according to the invention comprises a first recess which has a different helix angle than a second recess. The helix angle may, in the context of the present invention, be defined as follows. The angle defines the gradient of the recess with respect to the axis of rotation, that is to say the central longitudinal axis of the threading tool. Said helix angle is generally of equal magnitude even though the recess extends in spiral fashion from the distal end to the proximal end of the threading tool.

In a particular embodiment, the threading tool according to the invention comprises at least two different helix angles. In a particularly preferred embodiment, the helix angles are in a range between 35 and 50° with respect to the longitudinal axis. The helix angles are particularly preferably in a range of between 40 and 50°. Owing to the variable helix angles, it is the case, if a multiplicity of recesses is provided, that the respective recesses are spaced apart from one another differently at different locations on the longitudinal axis of the threading tool. In this way, the cutting element can be made larger or smaller at certain locations. In a particular embodiment, the depths and the widths of the recess are of equal magnitude.

In a particular embodiment, the threading tool comprises three recesses, each with a particular helix angle.

A further aspect of the present invention relates to a threading tool which, as already mentioned above, may have any desired combination of the embodiments of the aspects mentioned above, unless these are mutually exclusive or are contradictory to this fourth aspect, which has a distal machining region with a machining head and a proximal shank region with a shank. The threading tool comprises a machining region with recesses arranged around the machining head. In a particular embodiment, said recesses form a curling chamfer. At least one of said recesses is designed so as to transition from a spiral-shaped recess via a curve into a straight recess. In other words, said recess may start with a helix angle which however decreases over the course of the recess until it disappears entirely, or until the recess runs parallel to the central longitudinal axis of the threading tool and has the helix angle 0°.

In a particular embodiment, the core radius of the recess describes a curve which transitions into a straight line.

It is self-evident to a person skilled in the art that all of the stated embodiments may be combined with one another in any desired manner in a refinement of a threading tool according to the invention, unless said embodiments are mutually exclusive.

The present invention will be discussed in more detail below on the basis of figures and specific exemplary embodiments, without the present invention being restricted to these.

In the figures, for a simplified illustration, analogous elements will be denoted in each case by the same reference designations. In the figures, in each case schematically:

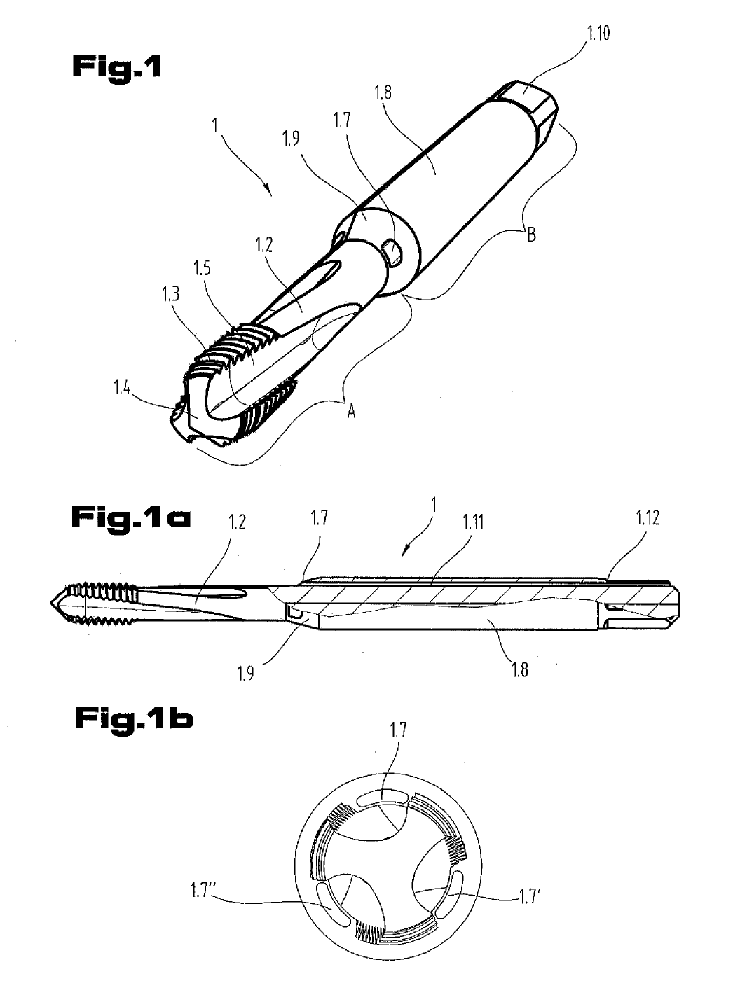

FIG. 1 shows a thread tap according to the invention;

FIG. 1a shows the thread tap of FIG. 1 in profile, with a partial profile cross section;

FIG. 1b shows the thread tap of FIG. 1 in a front view;

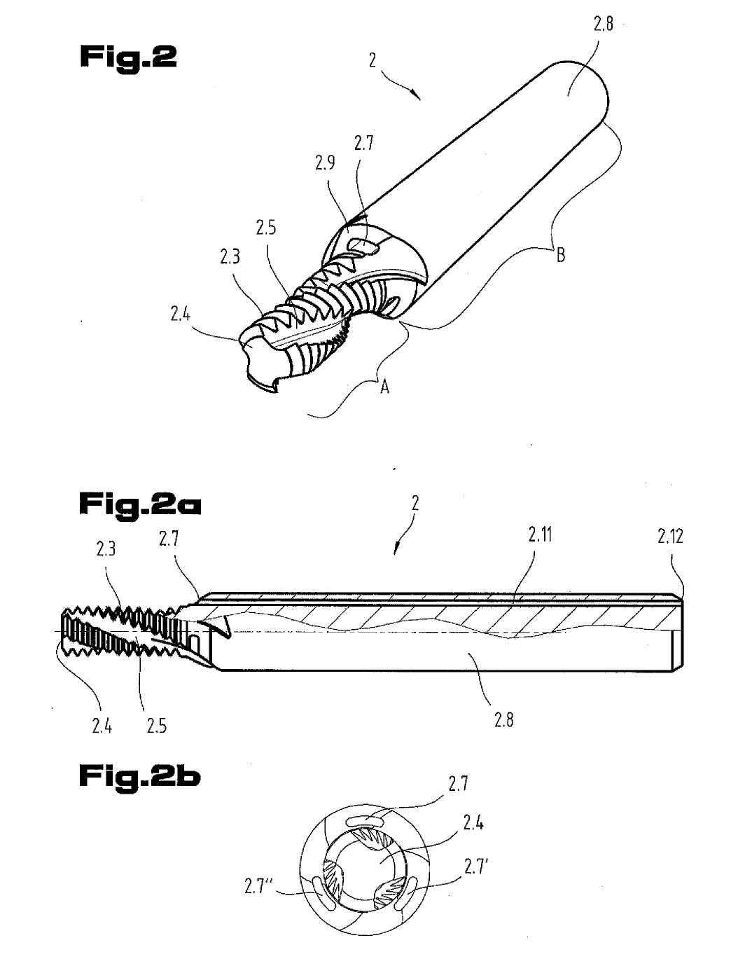

FIG. 2 shows a thread milling cutter according to the invention;

FIG. 2a shows the thread milling cutter according to the invention of FIG. 2 in a profile view with a partial cross section;

FIG. 2b shows a front view of the thread milling cutter from FIG. 2;

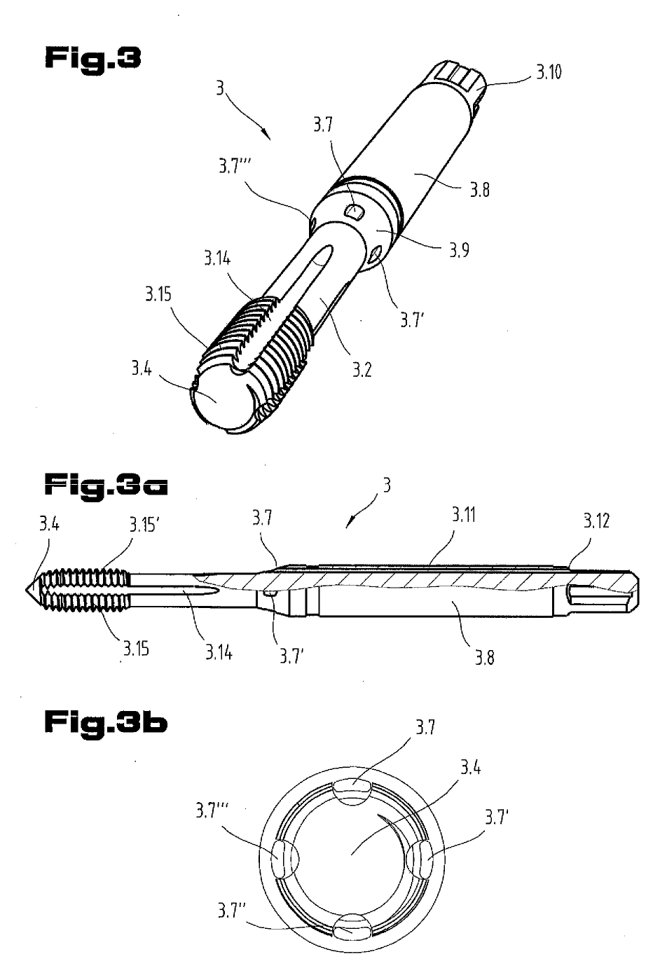

FIG. 3 shows a thread former according to the invention;

FIG. 3a shows the thread former of FIG. 3 in profile with a partial cross section;

FIG. 3b shows the thread former of FIG. 3 in a front view;

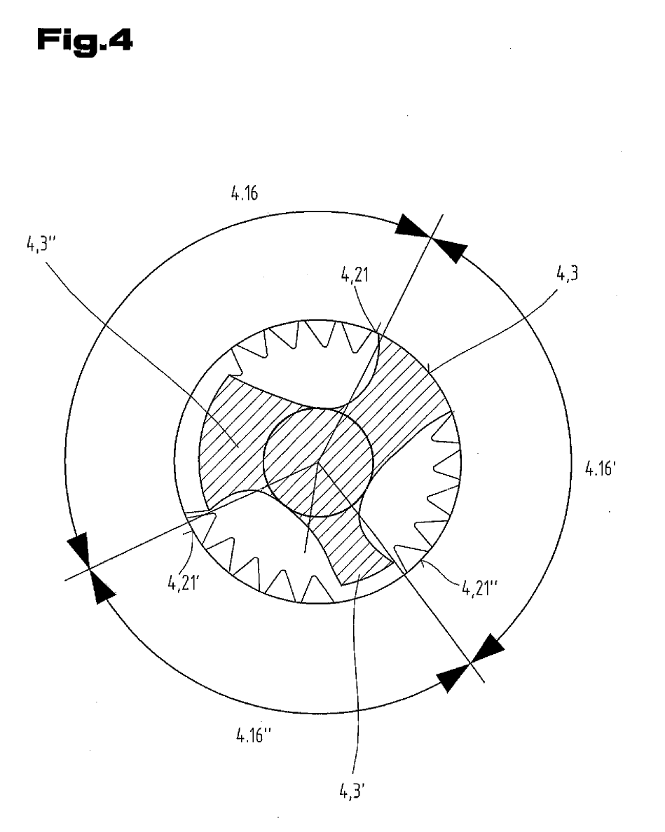

FIG. 4 shows a cross section through a thread tap with radially asymmetrically arranged cutting elements;

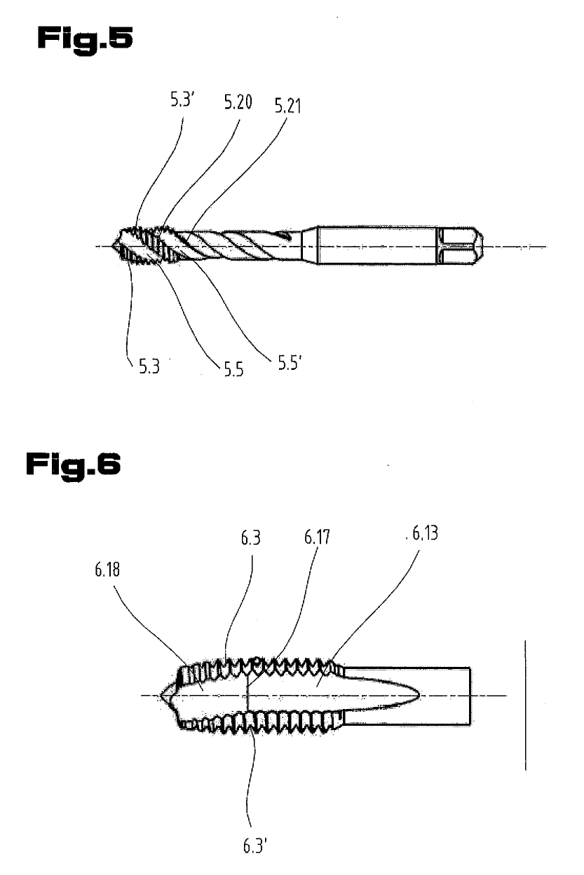

FIG. 5 shows a side view of a thread tap with variable helix angles;

FIG. 6 shows a side view of a thread tap with a transition from a spiral-shaped curling chamfer to a straight curling chamfer.

FIG. 1 shows, by way of example, a thread tap which is suitable for realizing the teaching according to the invention. The thread tap 1 can, broadly speaking, be divided into a machining region A and a shank region B. The machining region A comprises a machining head 1.2 which, at the distal end, has cutting elements 1.3. Overall, the thread tap 1 has three cutting elements 1.3 which are formed in each case from a row of cutting teeth arranged one behind the other. The cutting elements 1.3 of the thread tap 1 are spaced apart from one another in each case by an angle of 120°, and substantially form a triangle with respect to the central longitudinal axis of the thread tap 1. At its distal end 1.4, the thread tap 1 tapers to a point, and in the present embodiment, is conical. Chip discharge grooves 1.5 are provided between the cutting elements 1.3. The chip discharge grooves 1.5 begin directly behind the distal end of the thread 1 and extend over the entire length of the cutting elements 1.3, over more than four fifths of the machining head 1.2. In the present example, the chip discharge groove 1.5 is rounded and describes a helix around the machining head in order to facilitate the discharge of the chips. In the present example, the arrangement is of positive spiral-shaped form. The chip discharge groove may however also facilitate the supply of fluids, and may have an additional function as a circulating lubrication means. For this purpose, it is particularly advantageously the case in the present embodiment that the mouth 1.7 of the fluid duct is arranged substantially coaxially with respect to the chip discharge groove 1.5. The mouth 1.7 is arranged at the distal end of the shank 1.8, more specifically on a tapering shoulder 1.9 of the shank, whereby said mouth opens out in the machining head 1.2. In the present example, the number of fluid ducts (not shown) corresponds to the number of mouths 1.7, and said number in turn corresponds to the number of cutting elements 1.3 and corresponding chip discharge grooves 1.5.

At the proximal end of the shank 1.8 and of the thread tap 1, there is formed a clamping element 1.10 for clamping, with the action of an operative connection, in a machine tool. The clamping element 1.10 is, in the present example, in the form of a square-section profile, and, together with the shank, ensures said operative connection.

The tool shown by way of example is composed of a high-speed steel.

The arrangement of the fluid ducts makes it possible for a coolant or a lubricant to be conducted directly into the machining region. An additional positive effect is the additional internal cooling that is made possible by way of the fluid ducts in the tool.

FIG. 1 shows the thread tap schematically in a perspective view. The fluid ducts can be seen more clearly in FIG. 1a, which shows the thread tap 1 from FIG. 1 in profile with a partial cross section through a fluid duct 1.11. The fluid duct 1.11 extends substantially over the entire length of the shank 1.8. It has a mouth 1.7 at its distal end and correspondingly has an inlet 1.12 at its proximal end. The terms “mouth” and “inlet” are not chosen here so as to represent a limitation in terms of functionality. In most cases, a fluid is introduced through the inlet 1.12 into the fluid duct 1.11, which fluid then passes into the machining region at the mouth 1.7. It is however likewise conceivable for a suction effect to be used, and thus for the mode of operation of the individual elements of mouth 1.7 and inlet 1.12 to be reversed.

In the present example, the mouths 1.7 are formed on the shoulder 1.9, such that a fluid emerges substantially axially from the mouth after having been conducted in a fluid jet which is substantially parallel to the longitudinal axis of the tool.

FIG. 1b shows the thread tap 1 from FIG. 1 in a front view. It is possible to particularly clearly see the substantially triangular arrangement of the fluid mouths 1.7, 1.7′, 1.7″. Likewise clearly visible from said figure is the cross section of the fluid ducts. In this case, the fluid ducts are arranged so as to be oriented in substantially half-moon-shaped fashion relative to the central longitudinal axis. By way of this arrangement, it is possible to realize an ideal fluid curtain during the rotation of the thread tap, which ensures an optimum supply of a lubricant to the machining area.

The thread tap that is shown is designed so as to be suitable for producing conventional thread forms. In the present example, said thread tap has for example 9 rows of teeth, though may have between one and 25 rows of teeth, entirely in accordance with the ideas of a person skilled in the art and the required guidance of the thread tap. The illustration shows a thread tap for producing a single-flight thread. Embodiments for producing multi-flight threads can be derived from this by a person skilled in the art.

Likewise, the cutting edge geometry is of secondary importance for the embodiment of the threading tool according to the invention. A person skilled in the art will select the corresponding cutting edge geometry, such as lip width, draft angle, rake angle and chamfer angle in accordance with the result to be achieved.

The recesses which sometimes, by way of their shape, define the cutting elements are, in the version shown, spaced apart from one another symmetrically by 120°. It is however also conceivable for the recesses to be spaced apart asymmetrically, in the case of a thread tap with three cutting elements of for example 130°, 110° and 120°. In the present example, all three recesses have the same helix angle (not shown). Furthermore, in the embodiment shown, both the core radius and the helix angle are constant along the tool axis.

FIG. 2 shows a thread milling cutter 2 according to the invention. Said thread milling cutter can also be divided into a shank region B and a machining region A. The entire shank region B is formed by the shank 2.8, which tapers via a shoulder 2.9 into a machining head. The machining head has, in the present case, three cutting elements 2.3 and chip discharge grooves 2.5 which are spaced apart by in each case three cutting elements 2.3, which chip discharge grooves in turn form a lubricating groove 2.5. By contrast to thread taps (FIG. 1), the thread milling cutter 2 is formed with a flat distal end 2.4. The mouths 2.7 of the fluid ducts are arranged on the shoulder 2.9.

Analogously, FIG. 2a shows the thread milling cutter 2 in profile with a partial cross section. In this case, too, the fluid duct 2.11 extends through the entire length of the shank 2.8, and an inlet 2.12 permits the supply of a fluid through the fluid duct 2.11, which runs parallel to the central longitudinal axis, to the mouth 2.7 in the machining region, and also again substantially coaxially with respect to the chip discharge grooves 2.5. The twist of the chip discharge grooves follows that of the cutting elements 2.3. The distal end 2.4 is flat.

FIG. 2b shows the front view as seen from the distal end, with the three mouths, and corresponding fluid ducts, arranged in triangular fashion with respect to one another.

FIG. 3 correspondingly shows a thread former according to the invention. Analogously to the preceding threading tools, the thread former also has a shank 3.8 which ends at the proximal end with a clamping element 3.10 for the operative connection to a machine tool; in the present example, the clamping element 3.10 is in the form of a square-section profile. The shank tapers toward the machining head 3.2 via a shoulder 3.9, on which a row of mouths 3.7, 3.7′, 3.7″, 3.7′″ are arranged radially around a central longitudinal axis. The present thread former 3 has a total of four fluid ducts and four mouths 3.7, 3.7′, 3.7″, 3.7′″. The mouths 3.7, 3.7′, 3.7″, 3.7′″ are arranged coaxially with respect to lubricating grooves 3.14, of which there are in turn a total of four and which extend from a proximal region of the machining head 3.2 as far as the very distal end 3.4 of the thread former 3. The thread former 3 that is shown has a total of four pressing lobes 3.15, 3.15′ with lens-shaped polygonal teeth.

An advantage of thread forming in relation to thread milling and/or thread tapping is that no chips accumulate during the machining, which increases the process reliability overall. Also, thread formers for relatively large thread depths and thickened material structures can be realized by way of deformation. In the case of expensive materials, it is furthermore the case that there is no significant loss of material.

FIG. 3a then also shows the thread former in profile with a partial cross section, analogously to the corresponding figures relating to the thread tap and to the thread milling cutter. In this case, too, the fluid duct 3.11 extends over the entire length of the shank 3.8 to the mouth 3.7 proceeding from an inlet 3.12. The inlet 3.12 is formed directly adjacent to the clamping element, such that said inlet can be connected particularly expediently to a corresponding fluid supply. In this example, too, the clamping element is in the form of a square-section profile. The mouth 3.7 is again situated on a tapering shoulder, and in the present example, is formed coaxially with respect to a lubricating groove. In the present example, the lubricating groove 3.14 is formed coaxially with respect to the mouth 3.7′. The lubricating grooves 3.14 space the pressing lobes 3.15 and 3.15′ apart in each case. The distal end 3.4 is, as a centring tip, designed so as to be conical and so as to taper to a point.

FIG. 3b illustrates the arrangement of the mouths 3.7, 3.7′, 3.7″ and 3.7′″ in a plan view from said distal end 3.4. Here, the mouths are in each case spaced apart from one another by an angle of 90°, which ensures rotational symmetry of the tool about the central longitudinal axis.

In this embodiment, it is furthermore the case that the lubricating grooves and pressing lobes are spaced apart from one another in each case by an angle of 90°, which ensures rotational symmetry of the tool about the central longitudinal axis. Analogously to the thread tap or the thread milling cutter, the pressing lobes or the cutting elements may be spaced apart from one another asymmetrically.

Numerous further advantageous embodiments emerge to a person skilled in the art from the examples shown and from the abovementioned general embodiments of the teaching according to the invention.

With the present invention, a threading tool is provided which permits a high throughput by way of simultaneous internal and external cooling and a supply of a fluid to a machining zone, which is precisely controllable and permits a good distribution of the fluid.

With the present invention, a threading tool is provided which has a relatively long service life. Without restriction to this theory, such an increase in service life may be made possible by way of the simultaneous internal and external cooling and the supply of a fluid to the machining zone. Said supply may be controlled in a precise manner, and in accordance with the required location, by way of the form of the cooling ducts.

Owing to the coolant and lubricant curtain produced at the required location by way of the present invention, it is possible in particular to prevent lubricant film separation at the contact zone in the machining region between threading tool and the material to be machined. A constant lubricating film prevents and considerably delays adhesive wear. Furthermore, by way of the coolant curtain at the required location, the cooling is improved, in particular in the case of the thread tap.

For the production of a compact coolant and lubricant curtain, it is advantageous to provide a defined coolant pressure, which is usually provided by way of a pump of the coolant treatment system.

The preferred defined coolant pressure amounts to at least 10 bar, in order that a significantly improved cooling and lubricating action is also realized. The optimum operating range of the present invention lies at a coolant pressure of 40 to 90 bar or, in the case of certain tool constructions, even higher.

FIG. 4 shows a threading tool according to the invention in profile cross section at the distal end. FIG. 4 serves for illustrating an aspect of the present invention in which the threading tool head has cutting elements which are spaced apart from one another differently, that is to say which are not oriented rotationally symmetrically about the central axis of rotation of the threading tool. The corresponding threading tool has three cutting elements 4.3, 4.3′ and 4.3″. Said cutting elements are designed differently and have in each case one cutting edge 4.21, 4.21′, 4.21″. Measured from cutting edge to cutting edge, the cutting elements span an angle 4.16, 4.16′, 4.16″. The threading tool that is shown by way of example spans a total of three such angles 4.16, 4.16′, 4.16″, which make up a total angle of 360°. In the present example, a first angle 4.16 spans an angle of 143°, a second angle 4.16″ spans an angle of 101°, and a third angle 4.16′ spans an angle of 116°.

FIG. 5 shows an aspect of the present invention in which a row of recesses 5.5, 5.5′ have mutually different helix angles. The threading tool which is shown has a total of three cutting elements 5.3, 5.3′ which are arranged radially around the central longitudinal axis. Between said cutting elements there are provided recesses, composed for example of chip discharge grooves, which likewise twist radially and helically around the central longitudinal axis of the threading tool. If said recesses have mutually different helix angles, this gives rise to the different spacings between the recesses 5.5, 5.5′. In the present example, the cutting elements are thus formed with greater or lesser thickness (with respect to their extent in the longitudinal direction of the threading tool). A first thickness 5.20 in the longitudinal direction is greater than a second thickness 5.21 in the longitudinal direction.

FIG. 6 shows an aspect of the present invention in which a threading tool has a helix angle which describes a curve and decreases to zero. FIG. 6 shows a machining head with cutting elements 6.3, 6.3′ which are interrupted by a recess which transitions from a spiral-shaped first recess 6.18, which starts at the distal end, via a transition zone 6.17 to a straight-running recess 6.13. Said straight-running recess runs parallel to the longitudinal axis of the threading tool.

The improved running smoothness of the threading tool owing to asymmetrically arranged cutting edges or different helix angles of the recesses and the transition-free curling chamfer increased the service life of the tool. Furthermore, it is also possible, for the chip discharge to be significantly influenced, and thus likewise for the service life of the threading tool to be improved, by way of increasing or decreasing core radius of the recess.

1: Threading tool for producing a thread notch on a workpiece, wherein the threading tool comprises at least two regions:
a) a distal machining region with a machining head, and
b) a proximal shank region with a shank, and
wherein at least one fluid duct extends through the shank, which at least one fluid duct opens out in the machining region.

2: Threading tool according to claim 1, wherein the tool is a thread tap.

3: Threading tool according to claim 1, wherein the tool is a tool for the chipless production of a thread notch, in particular a thread former.

4: Threading tool according to claim 1, wherein the tool is a chip-removing tool for the production of a thread notch, in particular a thread milling cutter.

5: Threading tool according to claim 1, wherein the shank region is separated from the machining region by a shoulder, and wherein in particular, the shank narrows toward the machining head.

6: Threading tool according to claim 5, wherein, on the shoulder, there is provided at least one mouth at which the at least one fluid duct opens out in the machining region.

7: Threading tool according to claim 1, wherein the at least one fluid duct runs parallel to the central longitudinal axis.

8: Threading tool according to claim 1, wherein a multiplicity of fluid ducts is provided, which fluid ducts are arranged radially around, and parallel to, a central longitudinal axis of the tool.

9: Threading tool according to claim 8, wherein the fluid ducts are spaced apart by a certain angle, in particular such that the shank is configured substantially rotationally symmetrically about the central longitudinal axis of the tool.

10: Threading tool according to claim 1 wherein the shank is configured such that it can be clamped in a machine tool, wherein in particular, the shank has at least one clamping element or the shank is configured such that it can be clamped in a machine tool, wherein in particular, the shank has a square-section profile as a clamping element at the proximal end.

11: Threading tool, in particular according to claim 1, comprising a distal machining region with a machining head and comprising a proximal shank region with a shank, wherein the machining region has a multiplicity of cutting elements which are arranged radially about a central longitudinal axis of the tool, and wherein the cutting elements span a certain angle relative to one another, and wherein at least two angles spanned in this way are of different magnitude.

12: Threading tool, in particular according to claim 1, comprising a distal machining region with a machining head, and comprising a proximal shank region with a shank, wherein the machining region has multiple recesses which are arranged around the machining head and which extend in spiral fashion in the longitudinal direction of the tool about the longitudinal axis, and a first recess has a different helix angle than a second recess.

13: Threading tool, in particular according to claim 1, comprising a distal machining region with a machining head and comprising a proximal shank region with a shank, wherein the machining region has recesses which are arranged around the machining head, in particular has at least one curling chamfer, of which at least one is designed so as to transition from a spiral-shaped recess via a curve into a straight recess.
